(19) United States
(12) Patent Application Publication
(10) Pub. No.: US 2013/0078447 A1
(43) Pub. Date: Mar. 28, 2013

(54) ELECTROSTATIC DISCHARGE TRANSPARENT SHEETING

(71) Applicant: Kek Hing Kow, Shenzhen (CN)

(72) Inventor: Kek Hing Kow, Shenzhen (CN)

(73) Assignee: ESD TECHNOLOGY CONSULTING & LICENSING CO., LTD, Shenzhen, Guangdong (CN)

(21) Appl. No.: 13/697,371

(22) PCT Filed: May 10, 2011
(86) PCT No.: PCT/CN2011/073888

§ 371 Date: Nov. 11, 2012

(30) Foreign Application Priority Data
May 11, 2010 (MY) PI2010002193

(51) Int. Cl. B32B 5/02; B32B 38/00; B32B 5/18; B05D 5/12; B82Y 30/00

(52) U.S. Cl. 428/311.71; 428/319.3; 427/121; 427/122; 156/60; 156/307.3; 977/742

(57) ABSTRACT

An electrostatic discharge (ESD) sheeting (10) comprises a conductive sheet (11), consisting of a cellulose fibrous or porous sheet which is treated with a carbon nanotube (CNT) solution to achieve the desire electrical conductivity, and impregnated with a thermoset resin material (13) through the process of permeation or osmosis in a controlled amount, to form a transparent polymeric sheet.

### TECHNICAL FIELD

The present invention relates to a field of static dissipative ESD mat which effectively drain static charges from floor or work surfaces away when grounded in an ESD sensitive electronic device manufacturing work site, more particularly to a cost-effective method in making an improved ESD mat which is transparent tear-proof, flexible, lightweight, heat resistant, chemical resistant and provides excellent static dissipative protection.

### BACKGROUND OF INVENTION

It is well known in the electrostatic discharge (ESD) control industry that the use of ESD mat for draining away harmful static charge is one of the important methods in the combat against ESD in a typical ESD-sensitive electronics manufacturing environment.

It is also a well known fact for those skilled in the trade that making a usable transparent ESD mat with precise permanent electrical property ranging from 1×10⁵ to 1×10⁷ ohm consistently for superior dissipation of static charge is never an easy task. Making a transparent ESD mat of the aforesaid precise property at a cheaper cost than a conventional ESD mat is even much challenging and tougher.

Various types of ESD mats are being invented over the years. Some of the prior arts cited include the following:

U.S. Pat. No. 4,438,174 disclosed an antistatic laminate material comprising a glass reinforced panel having an electrically conductive mesh disposed at or just below its operational surface. The panel surface can be smooth or textured, non-slip anti-glare configuration. However, the antistatic laminate comprising such conductive mesh will be prone to many insulative hot spots on its smooth or textured finishing surface. Figure A illustrates such behavior or phenomenon. Presence of insulative hot spots means that tiny pockets of static charge can be lurking around the finishing surface. This will endanger many today's highly static sensitive microchip dies from latent failure or catastrophic failure due to the very high density nature of new generation circuitry design with more transistors crammed into it.

The antistatic laminate with such laminate structure lacks physical flexibility to be used in applications that requires soft and highly flexible properties in products like static dissipative machine covers, static dissipative curtains, shoe covers, static dissipative chair covers and other flexible static dissipative tape applications etc. The antistatic laminate as highlighted in this prior art lacks commercial attractiveness as process of curing with liquid polyester resin is not only a slow process, it is also an expensive manufacturing method.

In U.S. Pat. No. 4,484,250, it discloses a washable dust collecting multilayer polymeric material consisting of sticky top static dissipative vinyl layer; inner conductive vinyl layer and a bottom static dissipative foamed layer as backing layer. However, such invented product lacks heat resistant property and it is not transparent.

In U.S. Pat. No. 4,491,894, it discloses an invention consists of flexible laminations of semi-conductive material to achieve superior strength. However, the configuration and material design is complex and entail a high cost of manufacturing the same.

U.S. Pat. No. 4,784,908 relates to adding to the melamine resin for the decor sheet a small amount of ionic salt which functions as a humectants and the core sheets are carbon filled paper with ionic salt. However, such invented decor sheet lacks flexibility and it is opaque.

U.S. Pat. No. 4,804,592 relates to coating of graphite or carbon material on thermoplastic film and then laminated to form a static dissipative laminate film. However, such invented static dissipative laminated film lacks visual transparency.

U.S. Pat. No. 4,885,659 relates to a static dissipative surface covering material which comprises a thermoplastic polymer layer and an electrically conductive, metalized, such as vacuum aluminum-coated glass fiber tissue material dispersed in or on to the thermoplastic layer to provide a static dissipative surface covering material. However, such invented static dissipative thermoplastic covering material lacks heat and chemical resistant property.

In a typical work bench that is used in the electronics industry, a static dissipative surface having a resistivity on the order of about 10⁵-10⁷ ohms/square (Test as per ANSI/ESD STM/S11.11) is needed for the assembly of electronic components. Such resistivity range is chosen so as to drain away static charge readily but yet not fast enough to create micro-sparks. It is also important to consider the ergonomic aspects of the workers in the work environment. It is for these reasons, the soft type of ESD mats are normally used to provide lining for surfaces such as the work bench. Soft type ESD mats are usually made of rubber or flexible PVC. However, the current soft type ESD mat in the market is facing numerous shortcomings which limits or hinders the reliability and full potential of this technology.

The first and major shortcoming is the generally lack of durability of the soft ESD mat. Conventional ESD mats mainly comprises of two (or three) main layers of polymeric materials (U.S. Pat. No. 4,885,659, U.S. Pat. No. 4,804,582). As a result, the final mat produced is relatively soft and will not be able to withstand any physical stresses in some demanding applications. Therefore, these ESD mats will easily get cut, stretched or damaged by sharp tools or by the assembled printed circuit boards. Even where graphite layers might be inserted between the polymeric layers (U.S. Pat. No. 4,804,582), the achievable mechanical strength is still relatively weak on the surface skin layer for effective application on the work bench. Similarly in U.S. Pat. No. 4,885,659 where metalized glass fibers were proposed to be incorporated as a distinct internal layer between the polymeric layers, the mechanical strength basically is still poor on the surface skin layer. In addition, the ESD mat will tend to develop curls at the edges after some time of usage. This will make bench operation very inconvenient and the folded or curled edges not only cosmetically untidy and unacceptable, it also makes the workplace more easily contaminated with dust or debris accumulation under the curled edges. For a person skilled in the art, a logical solution to obviate this problem is to have more or thicker polymeric layers incorporating into the mat. However, this approach will dramatically increase the cost of production of these mats and subsequently make the technology commercially less attractive. Furthermore, such thicker construction will somehow affect the flexibility of the ESD mat. Therefore, there is a strong industrial need to produce an ESD mat with better performance and durability and yet remains commercially attractive.

For those ESD mats using carbon impregnated polymeric materials, typically high carbon loadings are required to achieve the required conductivity. As a result of the high loading, the impregnated carbon powders tend to flake off from the surface should there be a rubbing or abrasive work flow on the surface causing unwanted contamination to the work place. For those applications utilizing the impregnated antistatic materials, such commercially available antistatic materials are migratory and will tend to migrate to the surface overtime. These migrated antistatic materials will be quite easily deteriorated or removed should there be any rubbing or cleaning action on the surface thereby affecting the desirable property of the antistatic material. Therefore, there is a need for further research to arrive at an ESD mat which will not easily introduce contaminants too.

The present invention aims to solve these problems of the existing prior art which are currently faced by the industry by producing an ESD mat which is tear-proof, transparent, flexible, light weight, heat resistant, chemical resistant and provides excellent static dissipative protection.

### SUMMARY OF INVENTION

The present invention discloses a transparent ESD sheeting comprises a permanent static dissipative or conductive sheet with a unique matt surface structure which is formed from the controlled amount of the thermoset resin (i.e two-component epoxy resin) which multi-functionally acts as a binding agent, a toughener, a clarifier, a flaking eliminator and a water resistant modifier simultaneously in a single application onto the cellulose paper or porous sheet to achieve an unique permanent conductive or static dissipative sheet capable of achieving various desirable properties for use in a an ESD-sensitive assembly environment.

The cellulose paper or porous sheet was pre-treated with electrical conductive carbon nanotube (CNT) solution through printing, coating or impregnation process to achieve the desire electrical conductivity. The controlled amount of thermoset resin is the amount that is sufficiently or fully absorbed by the cellulose paper or porous sheet without any excess so that there is no “overflow” which appears as shinny patches that can be physically seen on the surface of the coated or impregnated sheet. This controlled amount of the epoxy resin can be permeated from the bottom of the porous paper upwards onto its paper surface (process of osmoisis), or from the top of the porous paper downwards onto its bottom paper surface (process of permeation). This process is unique as it eliminates the needs of dispersing the CNT into the liquid epoxy system which is tedious and difficult. The surface appearance of the coated or impregnated paper or sheet using such “permeation” process will appear uniformly matt before and after curing.

In that way, conductive or static dissipative CNT printed or treated cellulose or porous sheet impregnated with thermoset material can surprisingly achieve very unique properties with the following vital advantages needed by the industry:
Permanent (non-migratory) conductive or static dissipative property.
Translucent to transparent finishing (in application whereby visual inspection or other graphic communication is needed for productivity improvement, etc)
Heat resistant surface finishing (good in assembly activities involving soldering, oven baking, other heat generating production process, etc in a typical semiconductor production and assembly operations).
Very high surface abrasive resistant (long term cost saving in maintenance and replacement cost due to high wear and tear).
Non-flaking (good for cleanroom application)
Can be very thin and very flexible (cost saving opportunity in application whereby thickness is not a concern i.e. install on top of a stainless steel table top, etc).

In addition, layers of such epoxy impregnated ESD fibrous sheet can be stacked up to form hard, strong and rigid thermoset panel block or coiled up to form tough cylindrical rod after curing to allow wider choices of applications or uses of the fabrication of smaller parts in an ESD-sensitive work assembly environment.

### BRIEF DESCRIPTION OF THE DRAWINGS

Other objects, features, and advantages of the invention will be apparent from the following description when read with reference to the accompanying drawings. In the drawings, wherein like reference numerals denote corresponding parts throughout the several views:

FIG. 1a depicts a cross sectional view of the basic components of the invention before thermosetting.

FIG. 1b shows more components of the invention before thermosetting.

FIG. 1c shows the porous fibrous sheet with non-glaring (matt) surface texture prior to thermoset curing;

FIG. 1d shows a thick layer of material attached to the cured thermoset-resin impregnated cellulose paper or fibrous sheet to form various ‘laminated’ products;

FIG. 1e shows layers of stacked up impregnated thermoset resin sheets prior to curing; and

FIG. 1f shows the coiled up sheet(s) of thermoset resin impregnated layer(s) forming a cylindrical rod.

### DETAILED DESCRIPTION OF THE PREFERRED EMBODIMENTS

In the following detailed description, numerous specific details are set forth in order to provide a thorough understanding of the invention. However, it will be understood by those of ordinary skill in the art that the invention may be practiced without these specific details. In other instances, methods, procedures and/or components have not been described in detail so as not to obscure the invention. Reference will now be made in detail to the preferred embodiments of the present invention, examples of which are illustrated in the accompanying drawings.

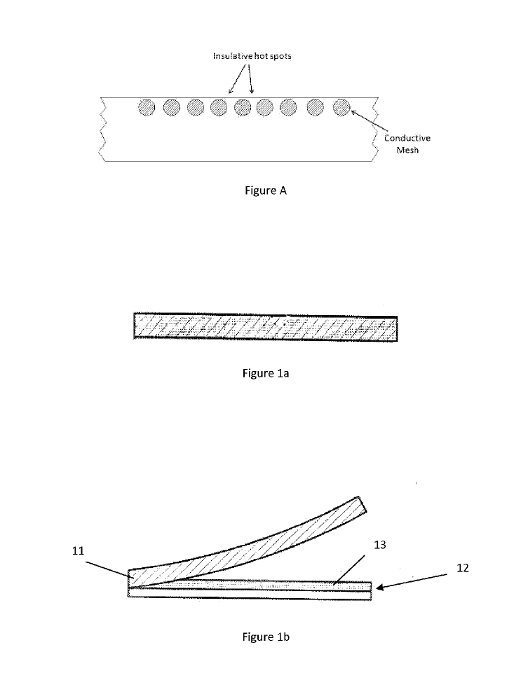

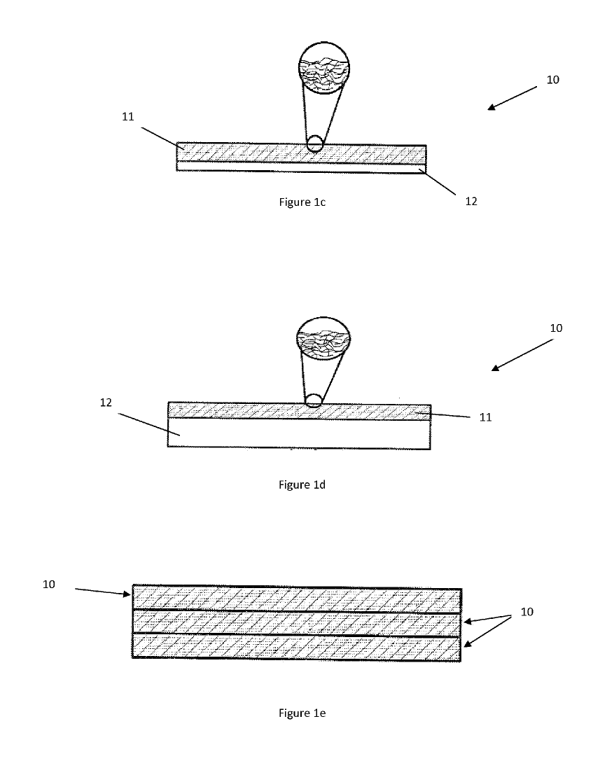

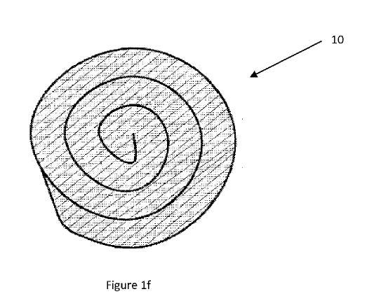

FIG. 1a depicts a cross sectional view of the epoxy resin permeated sheeting of the invention before thermosetting. The sheeting (10) includes a conductive sheet (11), consisting of a cellulose fibrous or porous sheet which is treated with a carbon nanotube (CNT) solution to achieve the desire electrical conductivity, impregnated with thermoset resin material (13) to achieve an electrical resistance in the range of 10⁴-10⁹ ohm/square measured as per ANSI/ESD STM 11.11 (USA), more specifically 10⁵-10⁶ ohm/square for use in an ESD-sensitive work assembly environment.

In FIG. 1b of a preferred embodiment of the invention, the cellulose fibrous or porous sheet (11) is pre-treated with the electrical conductive carbon nanotube (CNT) solution by soaking the sheet (11) in a well dispersed CNT solution in controlled proportion and concentration, and drying the soaked cellulose fibrous or porous sheet (11) by using air or oven. Alternatively, printing, coating or brushing can be done instead of soaking to achieve the same objective.

The surface of a transparent polymeric sheet (12) is evenly applied with the thermoset resin material (13) which is preferably a freshly prepared two-part epoxy resin using the conventional process of printing, coating or brushing to achieve the desirable objective. The CNT treated cellulose fibrous or porous sheet (11) is then permeated with freshly prepared epoxy resin by placing on top of the epoxy resin coated transparent polymeric sheet (12). Immediately after placing on top of such freshly prepared epoxy resin coated transparent polymeric sheet (12), the appearance of the cellulose fibrous or porous sheet (11) readily changed to a dark wet shade indicating that the freshly prepared epoxy resin has automatically penetrated into the CNT treated cellulose fibrous or porous sheet (11) and migrated to the surface.

The epoxy resin is used in a controlled amount which is sufficiently or fully absorbed by the cellulose fibrous or porous sheet (11) without any excess in order that there is no overflow that can be physically seen on the surface of the coated or impregnated sheet (11) as shown in FIG. 1c. This is a natural phenomenon of osmosis. It allows the pre-mixed epoxy resin coated on the polymeric sheet (12) to migrate upwards to the CNT coated porous surface sheet (11) and themo-set the weakly bond CNT network to form a strongly bond conductive or static dissipative, hard, durable, transparent or translucent surface finishing. It created a matt surface structure. The thermo-setting process can be ambient, heat or ultra-violet light curing. The thermoset resin acts as a binding agent, a toughtener, a clarifier, a flaking eliminator and a water resistant modifier simultaneously in a single application onto the cellulose fibrous or porous sheet (11).

After the epoxy resin (13) is fully cured, the transparent polymeric sheet (12) is then removed and a very flexible, highly abrasive resistant, wide range of solvents and chemicals resistant, translucent to transparent permanent static dissipative or conductive sheeting (10) is produced. Optionally, the transparent polymeric film backing can be remained intact to provide good strength and other properties like flexibility, sealability, pre-printed graphic, colour, etc.

In another embodiment, the CNT treated cellulose fibrous or porous sheet itself without the transparent sheet can be printed, coated or brush with a layer of freshly prepared epoxy resin in a controlled amount.

This controlled amount (by weight or by volume) of freshly prepared epoxy resin permeates from the top of the porous paper downwards onto its bottom paper surface (process of permeation) to achieve a uniformly epoxy resin impregnated sheet. Thus, this unique process, like the natural osmoisis process disclosed in the preceding embodiment eliminates the need of dispersing the CNT into a liquid epoxy system which is more expensive, tedious and difficult to manage.

It is also surprised to note that CNT printed cellulose fibrous or porous sheet (11) impregnated with thermoset resin material (13) can produced substantiately transparent finished product at an electrical resistivity range from 10⁵ ohm/sq measured as per ANSI/ESD STM 11.11 (USA). More particularly at 10⁷ ohm/sq, a printed graphic and wordings on the transparent polymeric film with a Times Roman font size of 8 can be seen with good clarity and acceptability. The level of transparency and toughness is not achievable with the current convention method of solvent based or water based resin impregnation or coating system.

This process is unique as it can produce a controllable electrical resistance sheet (mat) at a startling simple process with extremely low cost production set up. Practically, no heat is involved during the two-part thermoset impregnation process and no special equipment is required , just standard water based printing machine for coating the well dispersed CNT solution onto the cellulose fibrous or porous sheet (11) and followed by simple epoxy coating by brushing, via coating, silk-screening, etc.

Such invention can also be used to laminate the conductive CNT printed or impregnated cellulose or porous sheet (11) onto various types of substrates such as vinyl tile to become high performance laminated static dissipative vinyl tile; on conventional transparent vinyl sheet to become static dissipative transparent vinyl sheet; on foam pad to become static dissipative foam pad; on Perspex or acrylic sheet to become static dissipative Perspex or acrylic sheet. Without any lamination, such thermoset resin impregnated conductive CNT printed sheet can be used as a base material for the fabrication of heat resistant and chemical resistant heavy duty ESD floor tape and other heat and chemical resistant demanding application in a typical ESD-free workstation.

In addition, layers of such epoxy impregnated ESD fibrous sheets before curing can be stacked up together to form various thickness of panels or coiled up to form various sizes of cylindrical rods as shown in FIGS. 1e and 1f. Such panels or rods will form into precise panel blocks and cylindrical rods after curing through the use of simple and standard toolings. The intrinsically permanent ESD panel blocks or rods can be machined into various small parts for use in different application in todays many highly ESD-sensitive production work sites.

Therefore, an improved ESD mat or ESD sheet having a simple and unique structure that is tear-proof, transparent, flexible, lightweight, heat resistant and possesses permanent static dissipative or conductive ESD property is produced and invented.

In addition, an improved ESD thermoset panel or rod that is heat resistant, tough, abrasive resistance, chemical resistance and exhibiting permanent ESD property is also produced and invented.

As will be readily apparent to those skilled in the art, the present invention may easily be produced in other specific forms without departing from its essential characteristics. The present embodiments is, therefore, to be considered as merely illustrative and not restrictive, the scope of the invention being indicated by the claims rather than the foregoing description, and all changes which come within therefore intended to be embraced therein.

1. An electrostatic discharge (ESD) sheeting (10) comprising a conductive sheet (11), consisting of a cellulose fibrous or porous sheet which is treated with a carbon nanotube (CNT) solution to achieve the desire electrical conductivity, impregnated with a thermoset resin material (13) through the process of permeation or osmoisis in a controlled amount to form a transparent polymeric sheet.

2. The electrostatic discharge (ESD) sheeting (10) as claimed in claim 1, wherein said thermoset resin material (13) is a freshly prepared two-part epoxy resin.

3. The electrostatic discharge (ESD) sheeting (10) as claimed in claim 2, wherein said epoxy resin is used in a suitable controlled amount in such that it is sufficiently or fully absorbed by said cellulose fibrous or porous sheet (11).

4. The electrostatic discharge (ESD) sheeting (10) as claimed in claim 1, wherein said cellulose fibrous or porous sheet (11) can be a printed sheet.

5. The electrostatic discharge (ESD) sheeting (10) as claimed in claim 1, wherein said produced sheeting (10) has a resistivity in the range of approximately 10⁴-10⁹ ohm/square.

6. The electrostatic discharge (ESD) sheeting (10) as claimed in claim 5, wherein said produced sheeting (10) preferably having a resistivity in the range of approximately 10⁵-10⁶ ohm/square.

7. The electrostatic discharge (ESD) sheeting (10) as claimed in claim 5, wherein said produced sheeting (10) having a layer of transparent polymeric sheet attached as a backing.

8. The electrostatic discharge (ESD) sheeting (10) as claimed in claim 5, wherein said produced sheeting (10) having the transparent polymeric sheet (13) be removed after said epoxy resin is fully cured.

9. The electrostatic discharge (ESD) sheeting (10) as claimed in claim 5, wherein said produced sheeting (10) is used as floor mat in an ESD-sensitive assembly environment.

10. The electrostatic discharge (ESD) sheeting (10) as claimed in claim 5, wherein said produced sheeting (10) is used as base material for the fabrication of an ESD floor tape, foam pad or acrylic sheet.

11. The electrostatic discharge (ESD) sheeting (10) as claimed in claim 5, wherein said produced sheeting (10) is used to laminate on various types of substrates.

12. The electrostatic discharge (ESD) sheeting (10) as claimed in claim 5, wherein a plurality of produced sheeting (10) may be stacked up together before curing to form various thickness of panels.

13. The electrostatic discharge (ESD) sheeting (10) as claimed in claim 5, wherein a plurality of produced sheeting (10) may be coiled up together before curing to form various sizes of cylindrical rods.

14. A method for producing an electrostatic discharge (ESD) sheeting (10), said method comprising the steps of:
treating a conductive sheet (11) which consists of a cellulose fibrous or porous sheet with a carbon nanotube (CNT) solution to achieve the desire electrical conductivity;
impregnating said conductive sheet (11) with a thermoset resin material (13) through the process of permeation or osmoisis in a controlled amount for forming a transparent polymeric sheet.

15. The method as claimed in claim 14, wherein said conductive sheet (11) is treated by soaking said sheet (11) in a well dispersed CNT solution in controlled proportion and concentration.

16. The method as claimed in claim 14, wherein said conductive sheet (11) can be treated with CNT solution by printing, coating or brushing.

17. The method as claimed in claim 14, wherein said step of permeation includes said thermoset resin material (13) permeates from the top of the porous paper downwards onto its bottom paper surface.

18. The method as claimed in claim 14, wherein said process of osmoisis includes said thermoset resin material (13) disperses from the bottom of the porous paper upwards onto its paper surface.

19. The method as claimed in claim 14, wherein said method further comprising the step of laminating said produced ESD sheeting (10) on various types of substrates.

20. The method as claimed in claim 14, wherein said method further comprising the step of stacking up a plurality of produced ESD sheeting (10) before curing to form various thickness of panels.

21. The method as claimed in claim 14, wherein said method further comprising the step of coiling up a plurality of produced ESD sheeting (10) to form various sizes of cylindrical rods.
